(19) United States
(12) Patent Application Publication
(10) Pub. No.: US 2008/0183378 A1
(43) Pub. Date: Jul. 31, 2008

(54) MULTI-LEVEL PATH MAPPING FOR STREET GRID AND NON-STREET GRID ENTITIES

(76) Inventor: David P. Weidner, Woodinville, WA (US)

Correspondence Address: BLACK LOWE & GRAHAM, PLLC, 701 FIFTH AVENUE, SUITE 4800, SEATTLE, WA, 98104, US

(21) Appl. No.: 12/016,159

(22) Filed: Jan. 17, 2008

Related U.S. Application Data
(60) Provisional application No. 60/885,329, filed on Jan. 17, 2007.
(60) Provisional application No. 60/885,332, filed on Jan. 17, 2007.

(51) Int. Cl. G01C 21/20; G06F 17/00

(52) U.S. Cl. 701/201; 701/206

(57) ABSTRACT

A method and system for path mapping through a multilevel path is disclosed. One embodiment is a process that compares a level of a start node with a level of a destination node; in response to the level of the start node being different from the level of the destination node, selects at least one preferred transition between the level of the start node and the level of the destination node; for a first plurality of nodes and respective edges on the level of the start node, determines a first best sub-path from the start node to the transition; for a second plurality of nodes and respective edges on the level of the destination node, determines a second best sub-path from the transition to the destination node; and defines a recommended path corresponding to the first best sub-path, the transition, and the second best preferred sub-path.

### PRIORITY CLAIM

This application claims priority from provisional application Ser. No. 60/885,329 filed on Jan. 17, 2007 and from provisional application Ser. No. 60/885,332 filed on Jan. 17, 2007, both of which are incorporated herein by reference.

### BACKGROUND OF THE INVENTION

Conventional street level mapping can be used to provide directions from one location to another location. For example, directions may be provided from a starting street address to an ending street address. However, conventional street mapping techniques do not support mapping of entities which do not adhere to the street grid.

Further, such street mapping techniques do not support mapping of multi-level entities, such as a building or other architectural structure. For example, if the destination is to an internal location within the multi-level building, conventional street mapping techniques do not extend to mapping within the building itself.

Accordingly, a person following directions provided by a conventional street mapping device will only be able to get to the multi-level building at street level, but will not have directions once inside the multi-level building. In the same way, if the destination is a campus, a shopping mall, a downtown shopping center, an amusement park, a shopping mall, a county park, or the like, a conventional street-level mapping device will only provide directions to the street address of the destination, but will not provide directions to sites within the destination.

Conventional street mapping systems are available on the World Wide Web or may be implemented in Global Positioning System (GPS)-based devices. Directions from conventional street mapping systems are typically available as a list of directional information in the form of commands, distances and street names, or as real-time commands from a GPS-based system (i.e. “Turn left at the next street”). Alternatively, or additionally, such street mapping devices may provide directions in the form of a street map displayed on a display or may provide directions as a printed street map.

For source/destination directions where no street names or other location designations are available, the current web-based street map technology (e.g.; Google Maps, MapQuest, etc.) and GPS devices simply have no way to provide directions. Thus, a person seeking directions for traveling to a destination within a multi-level building, amusement park, a shopping mall, a county park, or the like, will not be able to use World Wide Web or GPS-based devices, particularly on a real-time basis.

GPS-based mapping/directions are able to provide current location and current left-right directions to guide the person to a destination. However, the person using the GPS-based directions is not provided a visually identifiable point of reference along the path of travel.

### SUMMARY OF THE INVENTION

A method embodiment is a process that compares a level of a start node with a level of a destination node; in response to the level of the start node being different from the level of the destination node, selects at least one preferred transition between the level of the start node and the level of the destination node; for a first plurality of nodes and respective edges on the level of the start node, determines a first best sub-path from the start node to the transition; for a second plurality of nodes and respective edges on the level of the destination node, determines a second best sub-path from the transition to the destination node; and defines a recommended path corresponding to the first best sub-path, the transition, and the second best preferred sub-path.

### BRIEF DESCRIPTION OF THE DRAWINGS

The preferred and alternative embodiments of the present invention are described in detail below with reference to the following drawings.

FIG. 1 shows a simplified map of a hypothetical park;

FIG. 2 shows a node and edge representation of the park of FIG. 1;

FIG. 3 shows a flow chart of a map definition algorithm used by an exemplary embodiment of the mapping system;

FIG. 4 shows a block diagram of an exemplary embodiment of the mapping system;

FIG. 5 shows an exemplary level dictionary used by an exemplary embodiment of the mapping system;

FIG. 6 shows four levels of a portion of a multi-level building;

FIG. 7 shows a flow chart of a multi-level path construction algorithm used by an exemplary embodiment of the mapping system;

FIG. 8 shows a flow chart of a tree of vertices construction algorithm used by an exemplary embodiment of the mapping system;

FIG. 9 shows a flow chart of a reverse path construction algorithm used by an exemplary embodiment of the mapping system;

FIG. 10 shows a flow chart of a best match transition algorithm used by an exemplary embodiment of the mapping system;

FIG. 11 shows node and edge reference definitions for establishing left and right direction instructions by an exemplary embodiment of the mapping system;

FIG. 12 shows a diagram of an edge array for determining relative location by an exemplary embodiment of the mapping system;

FIG. 13 shows a node and edge representation for mapping a point of reference entity;

FIG. 14 shows a block diagram of an exemplary alternative embodiment of the mapping system; and

FIG. 15 shows a flow chart of a point of reference computing algorithm used by an exemplary embodiment of the mapping system.

### DETAILED DESCRIPTION OF THE PREFERRED EMBODIMENT

This invention provides the techniques and technology for constructing maps of a single-level or multi-level architectural entity of interest that is not defined by the street grid. Additionally, this invention provides techniques for the generation of directions to and from points defined within the architectural entity of interest.

Path mapping and multi-level path mapping for street grid and non-street grid entities support is integral to several key scenarios, including entity within entity path mapping of an architectural entity of interest, facilitating special needs access for travel through an architectural entity of interest, and/or providing directions based upon point of reference (POR) objects or structures. A POR object or structure is a recognizable object located on or adjacent to the recommended path of travel. For example, directions may state “travel up Peachtree Street and turn left at the Waffle House.” The Waffle House is a POR object or structure.

Entities such as a shopping mall, a downtown shopping center, an amusement park, a county park, are nonlimiting examples of entities which may require multi-level directional mapping support by embodiments of the mapping system. Path mapping, multi-level path mapping and/or directions may be provided by embodiments of the mapping system. The maps and/or directions are presentable in a variety of formats. Embodiments of the mapping system support the mapping within these entities to facilitate point-to-point directions and least-cost path allocation to determine a recommend path of travel.

Special needs access to various types of structures, also referred to as entities, may be required by federal, state and local municipalities. Locating ramps, elevators and other special needs access structures may be provided by embodiments of the mapping system. Path mapping and multi-level path mapping supports the creation and use of maps. Embodiments may also provide directions to and/or locations of special needs access structures.

Embodiments of the mapping system may additionally, or alternatively, construct POR directions for street grid and non-street grid entities. POR directions allow the directional information to be specific to the physical location of an easily identifiable POR structure or object. Thus, POR directions do not need to rely on conventional compass directions, street names, or the like. POR directions may be visual and/or auditory in nature. POR directions provide directions that are context and location specific by utilizing significant points of reference markers to guide a person from one location to the next. For example, POR directions may employ “line of sight” information to a visible POR structure or object such that a person may view the POR structure or object from their current location. Further, POR directions may support the creation of verbal, textual or short message directions using such line-of-sight visible POR structures or objects within a street-grid or non-street grid mapped areas.

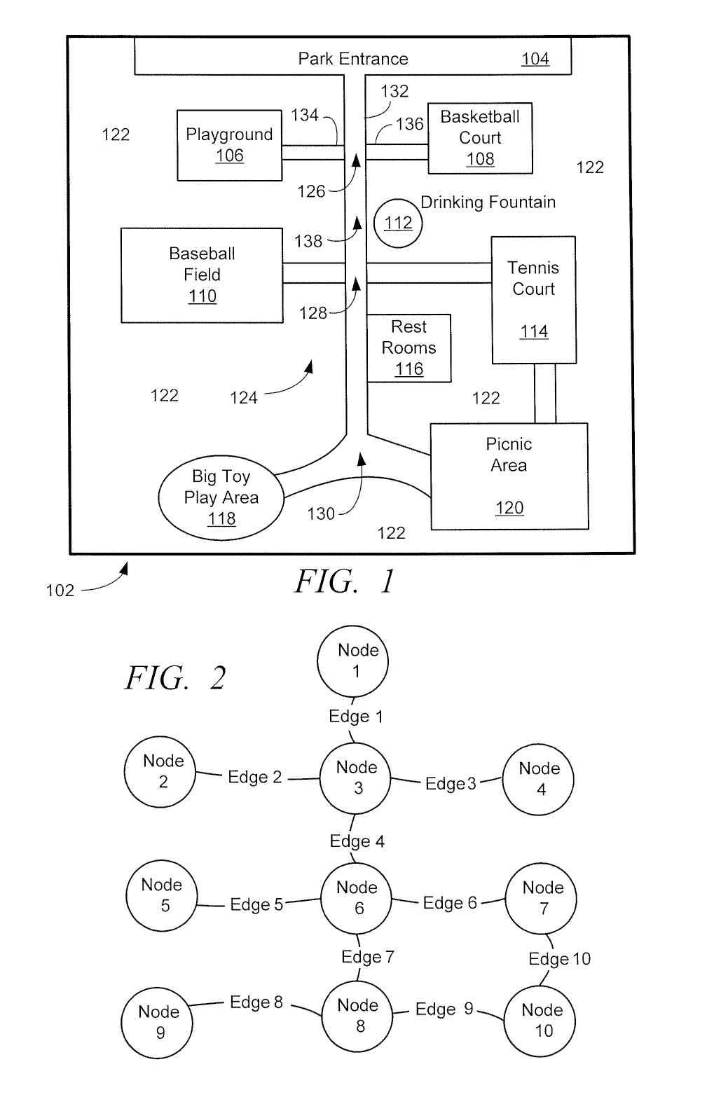

FIG. 1 shows a simplified single level hypothetical park 102. Embodiments provide a person with a map and/or directions between a current position and a destination within the park. The park 102 is an off-street architectural entity that conventional mapping systems may provide directions only to the street address of the park 102. As used herein, an architectural entity is an entity or a location (park, mall, multi-level building, campus, etc) which is mapped by embodiments of the mapping system. Further, a map is an abstract representation of the architectural entity to facilitate point-to-point mapping within the architectural entity. The map may also correspond to a container capable of containing maps allowing for an overview entity map which encapsulates 0 to n sub-entity maps.

The park 102 includes an entrance 104, a playground 106, a basketball court 108, a baseball field 110, a drinking fountain 112, a tennis court 114, rest rooms 116, a big toy play area 118, a picnic area 120, and unmapped areas 122 (e.g.: areas of grass, flower beds, etc.). Path 124 connects the above described areas of park 102.

FIG. 2 shows a node and edge representation of the park of FIG. 1. Table 1 below maps the park areas with the Nodes of FIG. 2.

TABLE 1
Park Nodes.

| | |
|---|---|
| node 1 | entrance 104 |
| node 2 | playground 106 |
| node 3 | path intersection 126 |
| node 4 | basketball court 108 |
| node 5 | baseball field 110 |
| node 6 | path intersection 128 |
| node 7 | tennis court 114 |
| node 8 | path intersection 130 |
| node 9 | big toy play area 118 |
| node 10 | picnic area 120 |

Nodes are connected to adjacent nodes by one or more edges or transitions. Transitions are a special class of edges which connect nodes located on different levels of an architectural entity. Nodes are identified by unique ID, and may be further identified by a friendly name and related to a specific level within the architectural entity.

An edge is a connector between nodes, such as a segment of the path 124. Edges are identified by unique ID, and maybe further identified by a name. Edges may be unidirectional or bi-directional. Edges may contain a “weight” or the like corresponding to a path feature, such as a distance or a difficulty associated with travel by a person (e.g.; suitability of travel by a person with a child's stroller or by a person in a wheel chair). Further, in situations where edges intersect, a node can be defined.

For example, Node 1 corresponds to the park entrance 104. Node 2 corresponds to the path intersection 126, where path segments 122, 134, 136, and 138 intersect. Edge 1 corresponds to the path portion 132 between the park entrance 104 (Node 1) and path intersection 126 (Node 3). Edge 2 corresponds to path segment 134 between the playground 106 (Node 2) and path intersection 126 (Node 3). Edge 3 corresponds to the path segment 136 between the basketball court 108 (Node 4) and the path intersection 126 (Node 3). Edges 4-10 may be similarly defined.

In this simplified example, the drinking fountain 112 and the rest rooms 116 are not defined as nodes. It is not necessary to have every feature of an architectural entity defined as a node. If the person seeks directions to either the drinking fountain 112 or the rest rooms 116, directions to these structures may be based upon directions to its respective edge. Embodiments of the mapping system provide maps and/or directions to such structures by determining which edge the structure is closest to, or by associating the structure with a particular edge(s), and then formulating the map and/or directions to that corresponding edge. Further, the non-node structure may be a point of reference feature (POR) that is used to provide POR-based directions, as described in greater detail hereinbelow.

Embodiments of the mapping system access a predetermined “map” of an architectural entity of interest. The architectural entity of interest is specified by the person (the “user”) using the mapping system. Further, a destination, such as a feature of interest within the architectural entity, is specified. Embodiments of the mapping system also acquire a current location of the user. The current location may be specified by the user. Alternatively, or additionally, the current location may be acquired from an external source such as a GPS device, a radio frequency (RF) proximity device(s), or the like. Then, embodiments of the mapping system construct the map and/or provide directions between the current location and the destination. The map of the multi-level architectural entity of interest may reside in a local or remote database wherein a plurality of maps for different multi-level architectural entities of interest reside.

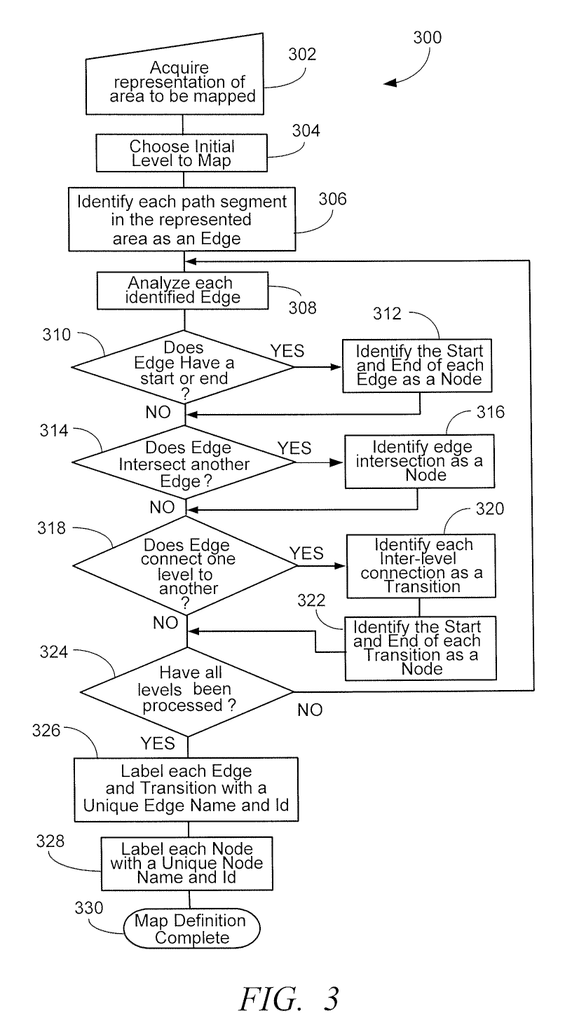

FIG. 3 shows a flow chart of an exemplary map definition algorithm 300 used by an embodiment of the mapping system. The map definition algorithm 300 may be executed manually by a person preparing the predetermined “map” of the architectural entity of interest, may be executed automatically by a suitable processing system, or may be executed in combination by the person and the processing system. For example, nodes and edges may be defined manually by the person based architectural drawings, aerial photographs, artist renderings, or the like, of the architectural entity of interest. Alternatively, or in addition to, the processing system may access and further process information describing the architectural entity of interest that is already available from another source. Other algorithms described herein below may be similarly executed.

The map definition system algorithm 300 determines the above-described predetermined “map” of the architectural entity of interest. The “map” is stored in a suitable location as a database or the like. The “map” may reside locally in an embodiment of the mapping system, may reside externally to embodiments of the mapping system and may be accessed as needed on a real-time basis, or may reside externally to embodiments of the mapping system and may be accessed prior to the user arriving at the architectural entity of interest.

At block 302 information corresponding to an area of the architectural entity of interest to be mapped is acquired. The area may be inclusive of the entire architectural entity of interest, or may be a portion of the architectural entity of interest, such as a level, floor, or region.

At block 304, the person or processing system chooses an initial level to map. For example, not all features of an architectural entity of interest need be included in the predetermined “map” of the architectural entity of interest. Thus, a person may make a subjective decision regarding the granularity of the “map” that is to be prepared. Or, the processing system may automatically determine the granularity of the “map” that is to be prepared based on the available information about the architectural entity of interest.

At block 306, path segments are uniquely identified and represented as an edge. At block 310, a determination is made whether the edge has a start and an end. If the edge has a start and an end (the YES condition), the process proceeds to block 312 where the start and/or end are defined as a node. For example, two edges may intersect, thus resulting in four separate edges, some of which do not have a start node and some of which do not have an end node. Nodes are then defined for both ends of the edge. Otherwise, the process proceeds to block 314.

At block 314, a determination is made whether the edge intersects another edge. If the edge intersects another edge (the YES condition), the process proceeds to block 316 where the intersection is defined as a node. Otherwise, the process proceeds to block 318.

At block 318, a determination is made whether the edge connects to another level. If the edge connects or another level (the YES condition), the process proceeds to block 320 where the inter-level connection is defined as a transition. Otherwise, the process proceeds to block 324. For example, the architectural entity of interest may be a multi-story building, and levels may correspond to different floors that are accessible by stairs, ramps, elevators, and/or escalators. As another nonlimiting example, the architectural entity of interest may be a very large theme park with different theme-based regions (levels), where the regions are only accessible through a limited number of access points. Such regions are referred to herein as levels, and the access points are transition edges. Levels are connected via transitions and are identified with a unique ID and/or name.

A transition is a specialized edge which connects two nodes residing on different levels in the architectural entity of interest. Transitions may be associated with a characteristic which represents the type of transition (i.e. ramps, escalators, elevators or any means of moving between entity levels). For example, a transition may be identified as a path that is suitable for special needs access.

The process proceeds to block 322 where the ends of the transition are defined as nodes. The nodes may be further identified as start and end nodes, as in the case of an escalator or the like where the path of travel is unidirectional.

At block 324, a determination is made whether all levels have been processed. If all levels have not been processed (the NO condition), the process proceeds back to block 308 so that the process is repeated for each level. If all levels have been processed (the YES condition), the process proceeds to block 326 where each edge and transition are uniquely identified with an identifier. At block 328, each node is uniquely identified by an identifier. Edges, transitions and nodes may also be identified or associated with a descriptive name or the like.

The process proceeds to block 330 and ends with completion of the map definition. That is, the predetermined “map” of the architectural entity of interest has been determined. The map definition algorithm 300 shows the architecture, functionality, and operation of a possible implementation of software for implementing logic that constructs the predetermined “map” of the architectural entity of interest. In this regard, each of the above-described blocks may represent a module, segment, or portion of code, which comprises one or more executable instructions for implementing the specified logical function(s). It should also be noted that in some alternative implementations, the functions noted in the blocks may occur out of the order noted in FIG. 3, may include additional functions, and/or may omit some functions. For example, two blocks shown in succession in FIG. 3 may in fact be executed substantially concurrently, the blocks may sometimes be executed in the reverse order, or some of the blocks may not be executed in all instances, depending upon the functionality involved. All such modifications and variations are intended to be included herein within the scope of this disclosure

Preferably, embodiments of the mapping system determine and recommend paths through an architectural entity of interest from a current location to a destination based upon directed graph theory. Directed graph theory facilitates computationally efficient determination of paths within an architectural entity of interest. The “map” is a path graph which holds the collection of all possible paths, or at least a predefined number of possible paths, from a starting location (node, edge, transition) on the map to a destination. The path graph is analyzed to determine the best path based on desired path properties or characteristics. An exemplary path property may include path distance (wherein a shortest distance path is the recommend path). Another nonlimiting path property relates to special needs structures, such as a wheel-chair accessible structure. Inaccessibility of a path edge by a person in a wheel chair would disqualify any potential path when special needs structures are required.

As noted above, paths may be described in terms of a series of nodes and their interconnecting edges. A path is comprised of a collection of path segments which define the course from one node, edge, or transition on the map to another node, edge or transition. A node pair and its respective connecting edge is a path segment. A path segment defines an ordered collection of nodes and edges representing the path from one point in the map to another. A series of path segments define the course from node to node, edge to node, node to edge or edge to edge along a path. Path segments can represent nodes and edges which define a sub-path within the same level, or nodes and edges (transitions) may define a sub-path from one level to another.

As noted above, a transition is a specialized edge that is between nodes on different levels. A level dictionary contains the information supporting the movement between levels. For each level, the level dictionary defines the levels that can be transitioned to from a particular level, the nodes on each level which anchor the transition, and specific characteristics or attributes of the transition between those nodes.

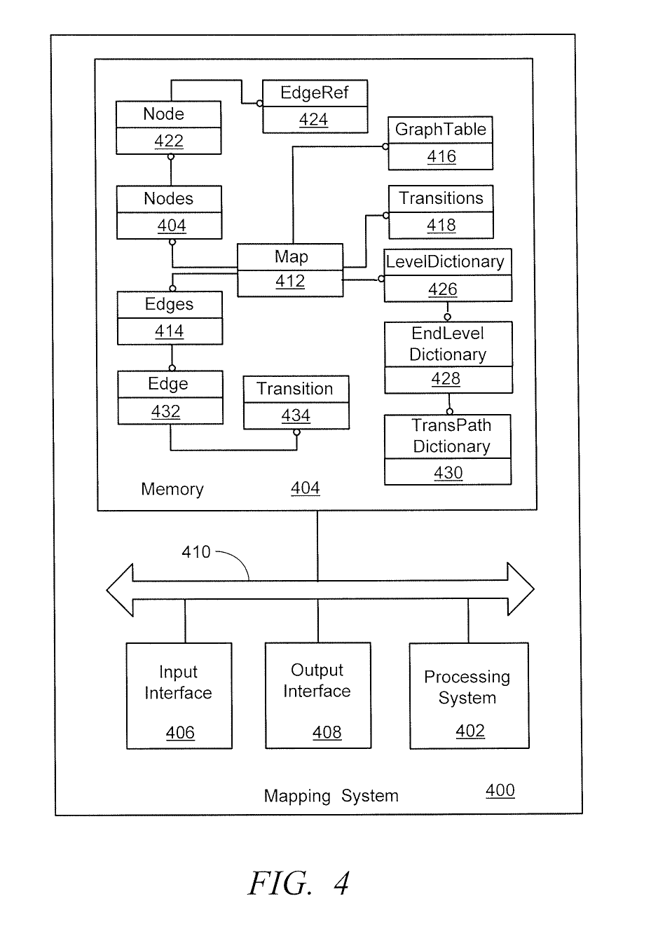

FIG. 4 shows a block diagram of an exemplary embodiment of the mapping system 400. Mapping system 400 comprises a processing system 402, memory 404, input interface 406, output interface 408, and bus 410.

Input interface 406 provides an interface with devices operable to receive inputs from devices directly accessibly by the user, or interface devices operable to receive information from another device. For example, the input interface 406 may be communicatively coupled to a keyboard, key pad, touch sensitive screen, audio processing device or the like such that a specification of the architectural entity of interest, starting location, and/or the destination may be received from the user. As another nonlimiting example, the input interface 406 may be communicatively coupled to a memory system that provides the predetermined map, that is, the data corresponding to, of the architectural entity of interest.

Output interface 408 provides an interface operable to output determined maps and/or directions. The output interface 408 may be operable to provide the maps and/or directions directly to a presentation device, such as a display screen, speaker, or other output device. In other embodiments, the output interface 408 may be operable to provide the maps and/or directions directly to another service or system. For example the maps and/or directions may be formatted and output to another device or system which communicates the maps and/or directions over the internet or other suitable communication media.

When logic associated with the algorithms described herein is implemented as software and stored in memory 404, one skilled in the art will appreciate such logic can be stored on any computer-readable medium for use by or in connection with any computer and/or processor related system or method. In the context of this disclosure, a memory 404 is a computer-readable medium that is an electronic, magnetic, optical, or other another physical device or means that contains or stores a computer and/or processor program. Logic can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with the executed logic. In the context of this disclosure, a “computer-readable medium” can be any means that can store, communicate, propagate, or transport the program associated with the logic for use by or in connection with the instruction execution system, apparatus, and/or device. The computer-readable medium can be, for example, but is not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium, could even be paper or another suitable medium upon which the program associated with the executed logic is printed, as the program can be electronically captured, via for instance optical scanning of the paper or other medium, then compiled, interpreted, or otherwise processed in a suitable manner, if necessary, and then stored in memory 404.

Processing system 402, memory 404, input interface 406, output interface 408 are coupled to bus 410 via the illustrative connections. For example, bus 410 is coupled to processing system 402 via a connection, thereby providing connectivity to the other above-described components. In alternative embodiments, the above-described components are connectively coupled to each other in a different manner than illustrated in FIG. 4. For example, one or more of the above-described components may be directly coupled to processing system 402 or may be coupled to processing system 402 via intermediary components (not shown).

The information in memory 404 corresponds to a map schema that illustrates the relationships of map components to the map itself. Individual data components are defined below.

The map 412 may be a table or the like that is a primary data item in the Map schema. Map 412 may support multiple levels. Map 412 is defined as follows:

| | |
|---|---|
| Name: | Unique name for this map |
| ID: | Unique ID for this map |
| Description: | Description of this specific map |
| Level Name: | Unique name for this level of the map |
| Level Number: | Number indicating the relative level. Unique for |
| | the map. |
| Edges: | Collection of edge definitions |
| Nodes: | Collection of node definitions |
| Connections: | Collection of Connection definitions |
| Transition Paths: | Collection of Transition Path definitions. |

Edges 414 define the connections between nodes. As noted above, a transition is a specialized edge that connects one level to the next. In general, all edges (and transitions) in the map are defined with the following data elements:

| | |
|---|---|
| Name: | Unique for the map |
| ID: | Unique for the map |
| Level ID: | Unique for the map |
| Direction: | Unidirectional or Bidirectional |
| Next Level: | Unidirectional or Bidirectional |
| Number Of Entities: | The number of entities (0-n) contained on this edge. |
| Edge Weight: | Indicates the level of difficulty in the path. |

In general, edge weight indicates a characteristic or feature of the edge, such as, but not limited to, path distance of the edge. When edges are processed at map load time, transitions and edges are separated into separate collections (Edges and Transitions).

Connections is a collection of Start Node-Edge-Endnode pairings. Connections are comprised of the following:

| | |
|---|---|
| Start Node Id: | Unique for the map |
| End Node Id: | Unique for the map |
| Edge Id: | Unique for the map |
| Transition Indicator: | Boolean |

The collection of connections definitions is parsed to create the Graph Array 416, such as a table or the like. The Graph Array 416 is a fast lookup table with each row defined as follows:
Edge Id, start Node, end Node, Transition
   If an edge is bidirectional the connection will have two entries in the Graph Array 416. For instance, if Edge 2 is bidirectional, is bounded by Node 1 and Node 4, and is not a transition, the Graph Array 416 will contain the following:
Edge 2, Node 1, Node 4, false;
Edge 2, Node 4, Node 1, false.

Transitions 418 define the intra-level paths from a level to other level in the map. Transition paths are defined for each level that can be transitioned to from a specified level with each transition path comprised of the following:

| | |
|---|---|
| Start Node Name: | Unique for the map |
| Start Node Id: | Unique for the map |
| Edge Name: | Unique for the map |
| Edge Id: | Unique for the map |
| End Node Name: | Unique for the map |
| End Node Id: | Unique for the map. |

Nodes 420 define edge endpoints. Nodes 420 is a collection of node definitions 422 with each node definition comprised of the following:

| | |
|---|---|
| Name: | Unique for the map |
| ID: | Unique for the map |
| Level ID: | Unique for the map |

Edge Ref List: List of edges that connect to this node, ordered clock-wise. This data feature supports left/right directions.

The Edge Ref 424 has objects, contained in the Edge Ref List, for each object. The Edge Ref 424 defines data unique to the edges that enter and exit a specific node. The data in Edge Ref 424 contains the following:

| | |
|---|---|
| Edge ID: | Unique for the map |
| Relative Value: | Unique value for this edge and this node representing this |
| | edge relative to other edges in the node. (See Left-Right |
| | Relative Location) |

Closest Entity Ref Id: This is the lowest or highest entity ID which is closest to the connection of the specified edge to the containing node.

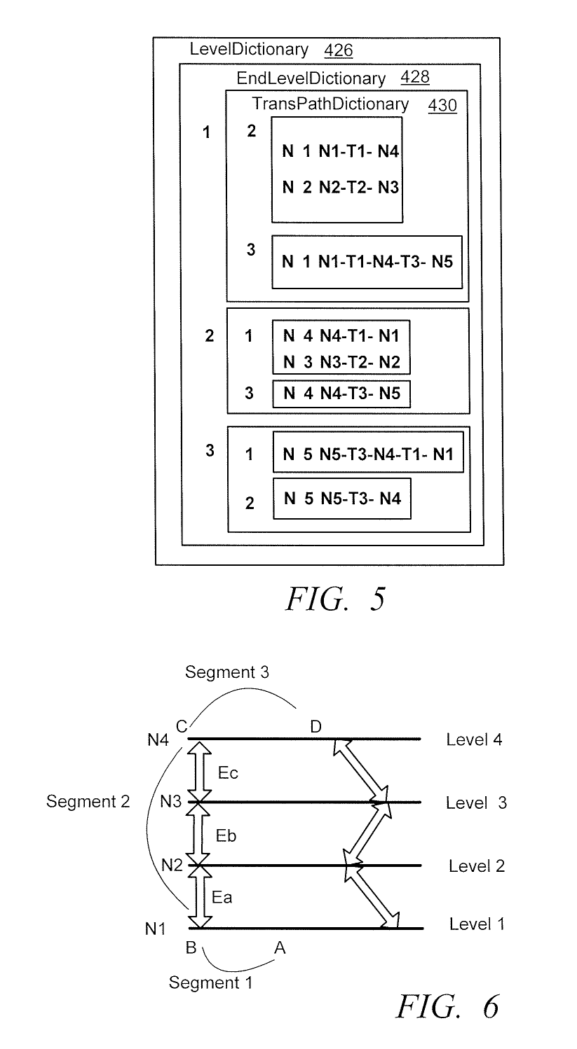

For efficiencies in computation, inter-level paths are captured in the Level Dictionary 426, End Level Dictionary 428, and Trans Path Dictionary 430. In this exemplary structure, the Trans Path Dictionary 426 is encapsulated in the End Level Dictionary 428. The End Level Dictionary 428 is encapsulated in the Level Dictionary 426. FIG. 5 illustrates the structure of an exemplary Level Dictionary 426 encapsulating the End Level Dictionary 428 and the Trans Path Dictionary 430.

The Trans Path Dictionary 430 is a collection of name-value pairs built from the Transition Paths defined above. The basic structure of a name value pair is:
Node Name, Path List
   The Node Name is the name of the start Node of a path. The Path List is a list of Path Items in the form Start Node-Edge-Node- . . . -Edge-End Node.

The End Level Dictionary 428 is a collection of name-value pairs and encapsulates the Trans Path Dictionary 430. The basic structure of the name value pair for the End Level Dictionary 428 is:
End Level, Trans Path Dictionary
   End Level The level number of the “ending level” in the lookup.
   Trans Path Dictionary: Dictionary of paths.

The Level Dictionary 426 is a collection of name-value pairs and encapsulates the End Level Dictionary. The basic structure of the name value pair for the Level Dictionary is:
Start Level, End Level Dictionary
   Start Level The level number one is starting from
   End Level Dictionary: Dictionary of Ending Levels encapsulating the paths that reach from the starting level to the desired ending level

At map loading time, the Map 412 is comprised of the following:
Nodes: The collection of all nodes for this map.
Edges: The collection of all edge objects for this map.
Graph Array: A fast lookup table derived from Connections ordered by Edge Id, and containing references to Start Node and End Node and an indication whether the Edge is a transition. If the edge is bidirectional, two entries will exist in the table for the specific Edge Id with the Start and End nodes reversed.
Transition Manager The Transition Manager is contained within the Map and manages path computations associated with transitioning between levels.
The primary components of the Transition Manager are:
Transitions: A collection of transition objects for the map
Level Dictionary: A nested dictionary-based structure which correlates each level to possible levels that can be transitioned to and correlating that to the possible transition paths available (start node, transition, end node).
   Because transitions are specialized (ramps, escalators, elevators, stairs, etc.) locating the best match transition is based on transition type.

Edge 432 corresponds to an edge. Transition 434 corresponds to a transition.

When a request for a map or a request for directions is received, map data corresponding to the architectural entity of interest is retrieved and loaded into the above-described map schema residing in memory 404. The loaded and validated map exposes interfaces for path construction. General multi-level path construction uses the concept of path segments to differentiate the paths that are level-specific and the paths that involve level transitions. This allows the resulting path to be utilized for directions which differentiate moving about a level from moving between levels. The advantage of this model is that most multi-level transitions can be addressed with a single direction statement such as, but not limited to, “Take the stairs to the 3rd floor” or “Take the elevator to the 6th level”.

Other embodiments may structure the retrieved map data using any suitable schema that is different from the map schema illustrated in FIG. 4. Such schema facilitates computation efficiency in the processing and analysis of retrieved map data for an architectural entity of interest.

FIG. 6 shows four levels of a portion of a multi-level building. In this illustrative example, a three segment path is generated by embodiments of the mapping system (rather than generating a single path from Point A to Point D). The recommended path is constructed of the following path segments:
Segment 1: Point A to Point B (traversing level 1)
Segment 2: Point B to Point C (traversing the transition from levels 1 to 4)
Segment 3: Point C to Point D (traversing level 4)

In this example, segment 2 may be comprised of four nodes (N1-N4) and three edges (Ea-Ec). Thus, the transition is identified by the following information pertaining to node 1, edge a, node 2, edge b, node 3, edge c, and node 4. Node 1 (N1) is a start node for the transition. Node 4 (N4) is an end node for the transition. In the exemplary model of FIG. 6, directions for the B to C (Segment 2) transition can be simply stated as “Take the Elevator to the 4th Level” or the like, depending upon the type of transition structure (here, an elevator).

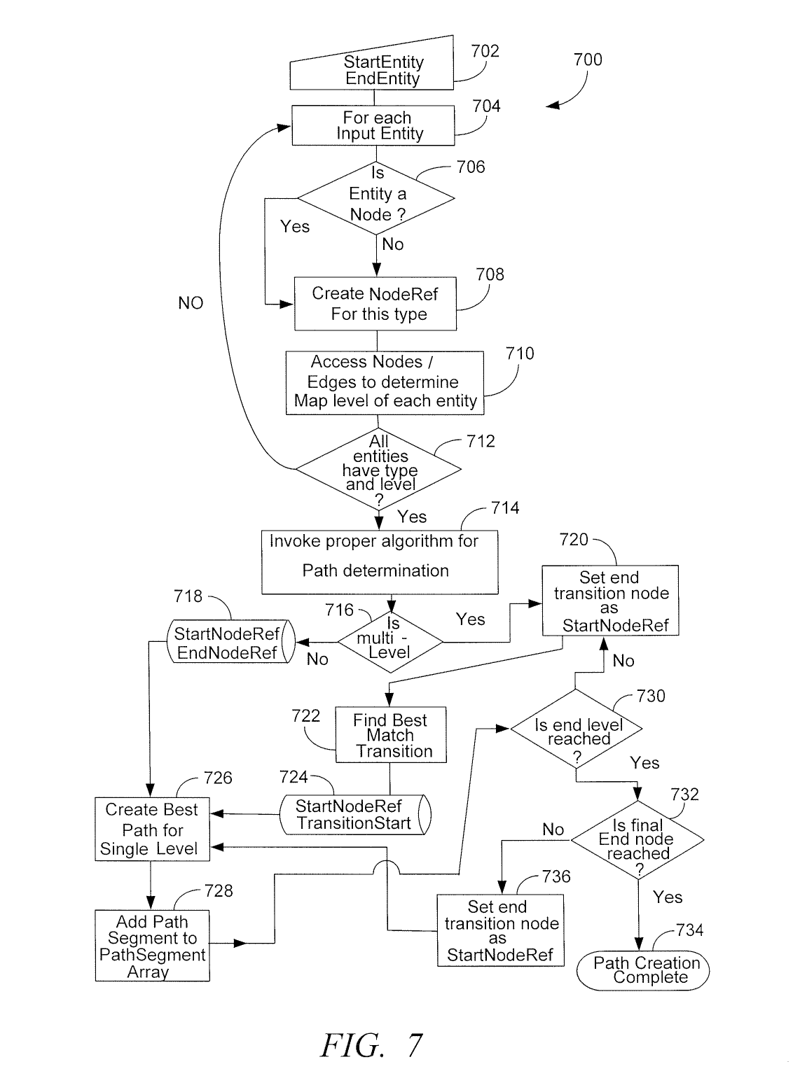

FIG. 7 shows a flow chart of a generalized, multi-level path construction algorithm 700 used by an exemplary embodiment of the mapping system. That is, the map and/or directions to be determined by embodiments of the mapping system constructs a path for travel between two or more levels of an architectural entity of interest. Generally, a data conditioning process occurs whereby data is retrieved for the map data of the architectural entity of interest. Possible paths are determined. Then, for each possible path, those paths traversing two or more levels are identified. Transitions are defined between the levels. A best sub-path for each level is determined. Then, the best sub-path for each level is linked with a corresponding best match transition between the respective levels such that a recommended path is determined.

The process starts at block 702, where a request for path instructions is received. The request identifies the architectural entity of interest, identifies a starting point (start entity) in the architectural entity of interest, and identifies a destination (end entity) in the architectural entity of interest. The starting point and destination may be provided by any suitable means to input interface 406 (FIG. 4).

At block 704, the map data for the architectural entity of interest is retrieved (the data comprising nodes and edges, generally referred to as an “entity”). At block 706, a determination is made whether the start point and the destination are a node or an edge. Embodiments look up the entity in a Nodes list of the map data to determine if entity is a node, otherwise the entity is an edge (the entity is absent from the Node list). If at block 706 the entity is a node, a Node Ref is created at block 708 for the node entity to populate a matrix or the like used by a directed graph path determination algorithm. If the entity corresponds to an edge, a Node Ref is also created for the edge entity to populate a matrix or the like used by the directed graph path determination algorithm.

At block 710, level information is retrieved for each entity (nodes and edges). At block 712, a determination is made whether the all entities of the retrieved map have been identified as either a node or an edge (and accordingly, have a corresponding Node Ref), and whether each entity is associated with a level. If all entities of the retrieved map of the architectural entity of interest are not identified with a Node Ref and/or are not associated with a level of the architectural entity of interest (the NO condition), the process returns to block 706 where the unprocessed entities are assigned a Node Ref and/or the level information is associated with its respective entity.

Then, when the above-described determination at block 712 is made whether the entities (nodes and edges) of the map data of the architectural entity of interest are processed (the YES condition), and the process proceeds to block 714. At block 714, algorithms to determine possible paths between the start node and the destination node are executed so that at least a plurality of possible paths may be determined.

Some embodiments may determine all possible paths between the start node and the destination node. Other embodiments determine a predefined number of possible paths. In some situations, the number of possible paths may be infinite, particularly in the case of repetitive path looping or circuitous paths (paths that transverse nodes that are clearly not along any reasonable path to the destination). Embodiments employ various known techniques to identify and eliminate such repetitive paths and/or circuitous paths from the family of possible paths, and accordingly, limit the amount of computing required for path determination.

The process proceeds to block 716. For each possible path in the identified family of possible paths, a determination is made whether the possible path is a multi-level path. If not (the NO condition), the process proceeds to block 718 where the start node and the end node are specified as the Start Node Ref and the End Node Ref, respectively, for that possible path. Data for the possible path is now ready for further processing to identify the recommended path (see block 726, described below).

However, if at block 716 the possible path is a multi-level path, the process proceeds to block 720. At block 720, the Node Refs (nodes and edges) for transitions between levels are identified. Nodes separated by identified transition edges are identified as a start node and/or an end node for the transition between its respective level i. For example, an elevator may provide the transition between the first floor and the fourth floor. The elevator entry on the first floor is a start node for the transition and the elevator door on the fourth floor is a end node for the transition. Further, the elevator door is an end node for a family or possible sub-paths (nodes and edges) on the first floor. Similarly, the elevator door on the fourth floor is a start node for a family of possible sub-paths on the fourth floor.

In some situations, a plurality of transitions between levels are determined. For example, there may be an elevator, an escalator, stairs, and a ladder connecting the above-described first floor with the fourth floor. The process proceeds to block 722 where at least one best match transition from the possible transition paths is identified. Finding the best match transition enables identification of a family or a sub-set of sub-paths to/from the identified best match transition. Accordingly, many sub-paths on the levels that do not use the identified best match transition may be eliminated from further processing.

In some situations, a plurality of preferred transitions may be selected from the plurality of possible transitions. Then, a best match transition may be determined from the plurality of preferred transitions such that the recommended path corresponds to the first best sub-path, the best match transition, and the second best preferred sub-path.

The best match transition may be based on any suitable criteria. For example, proximity to the starting point and/or the destination may be criteria. Type of transition may be another criteria. For example, an elevator may be preferable over stairs for a mother with a child's stroller (or the stairs may be preferable over the elevator for the fireman). Time required to traverse the transition may be a criteria. For example, a transition requiring the least time to traverse may be desirable. Or, another characteristic of the transition may be used. For example, the transition with the most scenic views may be desirable. In some embodiments, a characteristic may be used to eliminate a plurality of disqualified transitions from the plurality of possible transitions based upon the transition characteristic. For example, elevators and escalators may be eliminated for a fireman answering a fire alarm.

Returning to the example above, the best match transition for the elevator identifies a family of first floor sub-paths for traveling from the start node on the first floor to the elevator door on the first floor. Any first floor sub-path from the start node to the elevator door on the first floor may be identified as a possible sub-path. Similarly, for the escalator, the best match path to the escalator identifies a second plurality of first floor sub-paths associated for traveling from the start node to the escalator entrance on the first floor. The same is true for the stairs and the ladder which provide a transition path from the first floor to the fourth floor. The identified best match transition is added to the path segment array.

The process proceeds to 724 where, for each level, the start node of the best match transition is defined as an end node for the next level to define a subset of possible sub-paths for a level i. Also, the end node of the best match transition is defined as a start node for the next level to define a subset of possible sub-paths for the next level (level i+1). For example, the elevator door on the fourth floor is defined as the start node for a set of sub-paths which traverse the fourth floor. Similarly, the escalator exit (if selected as the best match transition) on the forth floor may be defined as a second start node for a set of sub-paths which traverse the fourth floor.

It is appreciated that in some situations, entire sets of the possible paths and/or sub-paths may be eliminated based upon the characteristics of a transition edge. If the person requires a special needs facility, the transition edges may be used to eliminate one or more possible paths. For example, the person may be a parent with a small child in a stroller. Accordingly, possible paths with the stairs and ladder as a transition edge may be eliminated. The person may be in a wheel chair, thus eliminating possible paths which have the escalator, stairs, and ladder as the transition edge. As another example, the person may be a fireman. During a fire, the elevator and the escalator may be placed out of service. Accordingly, possible paths with the elevator and the escalator as a transition edge may be eliminated for the fireman. Special needs may be identified with a special needs flag or the like associated with an edge or a node.

In some situations, the recommended path will have to traverse more than two levels. In such situations, a best match transition will be determined for traversing successive levels. For example, if in the above described example with four floors, the elevator door on the first floor may not be operable. Thus, a transition from the first floor using the stairs may be identified to get to the entrance of the elevator on the second floor. Here, sub-paths for the first floor to the stairs, from the second floor stairs to the elevator door on the second floor, and from the elevator door on the fourth floor to the destination will be identified. That is, three levels will be traversed by the user.

The process next proceeds to block 726. At block 726, the best sub-path for a current level is identified. Any suitable directed graph best path determination process may be used. Then, the process proceeds to block 728 where the identified best level sub-path is added to the path segment array. Initially, the process starts with the first level which has the initial starting point. For example, a best sub-path from the start point to the elevator door on the first floor is determined.

The process then proceeds to block 730 where a determination is made whether the end level has been reached. If not (the NO condition), the process proceeds back to block 720 where the end node of the transition edge is defined as the start node of the next level i. Then, the best path for that next level i, with respect to that particular transition edge, is determined. Otherwise, if the end level has been reached (the YES condition), the process proceeds to block 732.

At block 732, a determination is made whether the final destination end node has been reached. For example, the elevator door on the fourth floor in the example above may correspond to the final destination (such as the case where the elevator opens into a reception lobby of an office). Accordingly, if the final end node is reached (the YES condition), the process proceeds to block 734 such that path creation is complete.

However, if the final end node is not been reached, the process proceeds to block 736 where the transition edge end node is set as a start node for that corresponding next level i+1. The process proceeds to block 726 and continues as described above. Eventually, the final end node will be reached such that the process ends at block 734, and path creation is then complete.

Effectively, at block 734 where path creation is complete, a subset of paths will be determined. Each determined path will be comprised of a series of sub-paths for each level i connected by an intervening transition edge (where each sub-path for each level i has been optimized).

FIG. 7 describes one possible process of constructing a multi-level path map. Part of the process involves identification of a best sub-path for each level i. An exemplary best path determination for a level i is now described.

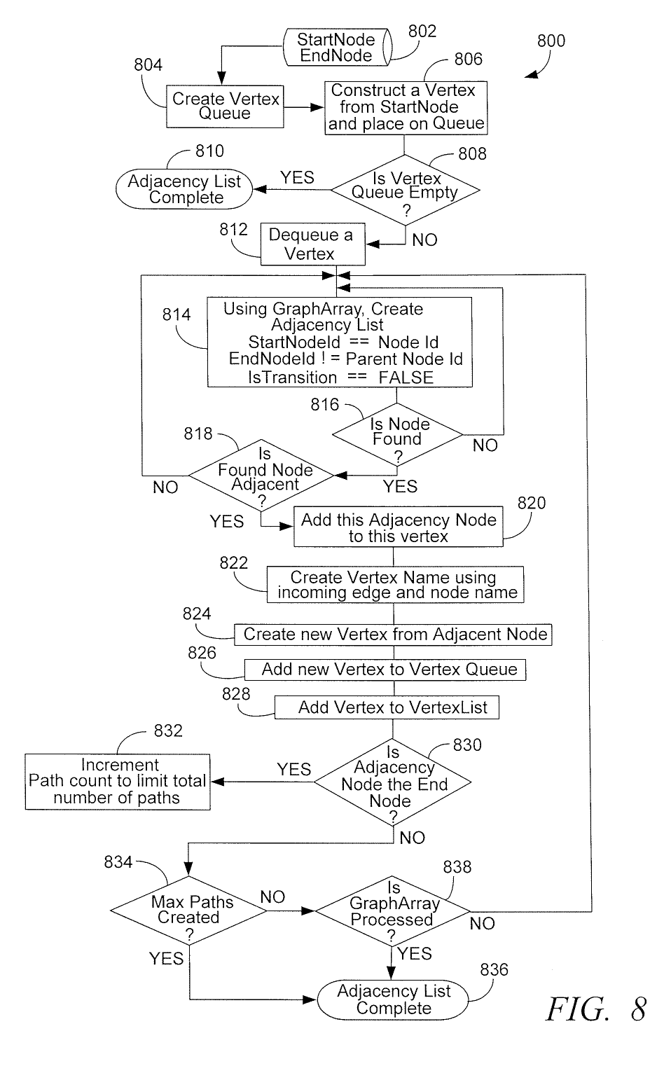

FIG. 8 shows a flow chart of a tree of vertices construction algorithm 800 used by an exemplary embodiment of the mapping system. The exemplary tree of vertices construction algorithm 800 is based on directed graph theory in this embodiment.

If there is a preceding level, the start node of the current level will have an edge to the end node of the transition edge that connects the previous level to the current level. If there is next level to be traversed after the current level, the end node of the current level will be edge connected to the start node of the transition edge that connects the current level to the next level.

The tree of vertices construction algorithm 800 is a single level best path construction algorithm that relies on a Vertex object. The Vertex object represents a node and its adjacent nodes. The Vertex object is also capable of signaling path construction events and receiving those path construction events to construct a path from the “end node” to the root (start node). The Vertex object contains the following key data items:
Vertex Name: A unique name constructed from the node id and the incoming edge id which is always unique for the map;
Is Root: An indicator that this node is the root of the tree;
Path Item List: The constructed path up to the current vertex; The path item list is used at path construction time and contains the node-edge-node combination that leads from the end node to this object;
Adjacency List The list of vertices adjacent to this vertex The Adjacency list identifies all nodes that can be traversed to from this node along with the edge associated with the adjacency node;
Parent Node The parent node of this vertex; and
Path Event: The event that is signaled to construct a path by adding this vertex to the path contained in the event arguments.

The algorithm 800 for computing the best path between two nodes on a single level is comprised of three steps: construction of the tree of vertices, reverse path construction, and right-ordering of paths. Generally describing FIG. 8, each Vertex has a Path Event Handler called Path Event. Whenever a child Vertex is added to the adjacency list of the Vertex being processed, the child Path Event is hooked with the parent Vertex's callback. This results in the construction of an “event” chain from the start node to the end node. The event chain can be recovered by signaling the last Vertex Path Event in the chain. Thus, the process loops through the list of vertices and determines if the ID of the vertex (Vertex.Self Id) is equal to the ID of the destination node. Starting with the last node, each node that is subsequently called via the callback and adds itself and its incoming edge to the path list. The path list is passed as an argument to the event. This process continues until the root of the tree (start node) is reached and the event chain is terminated.

In one embodiment, path construction is built upon the Microsoft.Net event technology. Events enable an asynchronous callback which allows an event provider to specify the content (Event Args) and connection point (Event Handler) for the event, and provide a means for recipients of that event to register with the Event Handler by providing a callback method which will be invoked whenever the event occurs. When an event occurs, the event provider constructs the Event Args and signals the event handler to propagate the event. The event handler then invokes the callback methods (with attached Event Args) specified by each component that registered with the event handler. In the case of Path Construction, the End Node Vertex is called to begin the propagation of path events. Each vertex which has the End Node Vertex as an adjacency node had previously registered to receive a Path Event. The End Node Vertex constructs the Event Args by adding itself (node) and it's incoming edge to the Event Args Path List. The event handler for the End Node Vertex then calls each of the registered recipients who subsequently add themselves (node and incoming edge) to the Path List and invoke their own event handlers to propagate the event. Other embodiments may use other suitable path construction technologies.

The process illustrated in FIG. 8 begins at block 802 with an identified family of possible sub-paths for a level i. The initial node on the current level i is defined as the start node and its last node on the current level i is defined as the end node. The start node and the end node will be the same for the family of possible sub-paths on the current level i. At block 804 a vertex queue is created.

At block 806, a vertex object is constructed from the start node and its corresponding incoming edge. This distinction is necessary to uniquely identify this specific edge entry into the node. This newly created vertex is added to the queue to be processed. At block 808, a determination is made whether the vertex queue is empty. If the vertex queue is empty (the YES condition), the adjacency list is complete and the end node is signaled to construct paths at block 810. If the vertex queue is not empty (the NO condition), the process proceeds to block 812 so that the tree of vertices is constructed from the adjacency list for each vertex. The adjacency list contains the list of all nodes and corresponding edges that can be reached from the current node.

Construction of the tree of vertices begins at block 812 where a vertex object is dequeued. Then, at blocks 814 to 818, an adjacency list is created using the Graph Array. Generally, an Adjacency node in the Graph Array is located if: Start Node Id is equal to the Node Id of the current Vertex, the End Node Id is not equal to the Parent Node Id of this Vertex, and Is Transition is FALSE (do not follow transitions to ensure the path stays on this level only. Transitions are dealt with as a special case). At block 820, adjacency nodes (vertices) are added to the Vertex adjacency list and each adjacent vertex is added to the queue for later processing. By creating the adjacency list for each vertex, the collection of all possible paths from the specified Start Node to the specified End Node is traversed start to end.

At block 822, a Vertex Name is created using the incoming edge and node name. At block 824, a new vertex is created from the adjacent node. At block 826, the new vertex is added to the vertex queue. At block 828, the vertex is added to the vertex list. Even though a “node” may exist multiple times in the list, it will only exist one time based on the vertex naming scheme which provides a unique name by pairing the incoming Edge ID with the Node ID.

At block 830, a determination is made whether the end node is reached. If an end node is reached (the YES condition), the process proceeds to block 832 such that a path count is incremented which ensures that an optimum number of paths is computed to the end node. If an end node is not reached (the NO condition) at block 830, the process proceeds to block 834 where a determination is made whether a maximum number of paths has been created.

This predefined maximum number of paths limits the total computations made by the algorithm 800 during execution by some embodiments. Accordingly, if at block 834 it is determined that a maximum number of paths has been created (the YES condition), the process proceeds to block 836 such that the adjacency list is complete. If not (the NO condition), the process proceeds to block 838 where the Graph Array is further processed (since more items remain for processing in the Graph Array).

At block 838, a determination is made whether the Graph Array has been completely processed. If not (the No condition), the process returns to block 814 and the process continues as described above. If the Graph Array has been completely processed (the YES condition) this indicates that based on the current vertex (node) the entire map has been scanned to determine if there exists any adjacency nodes. If the Graph Array has not been fully processed (the NO condition) the process proceeds to block 838 where the Graph Array is further processed to find additional nodes adjacent to the current node (vertex) since more items remain for processing in the Graph Array.

The tree of vertices is complete when adjacency list construction cannot proceed further or when the maximum number of computed paths has been reached. Once the tree of vertices is computed, the list of Vertices is processed to perform path construction. In some embodiments, this path construction is done in reverse—from the Destination Node to the Start Node. This process minimizes the searching and yields complete paths. The actual construction of the path essentially occurs when the tree of vertices is first created. The algorithm for reverse path construction is executed, starting by causing each vertex in the collection of vertices representing the End Node to fire its path creation event. As each event in the chain subsequently fires, the vertex handling the event adds itself (node and incoming edge) to the path that has been constructed by the previous vertexes in this path. This event based path creation process terminates when the Vertex representing the start node is reached for all created paths.

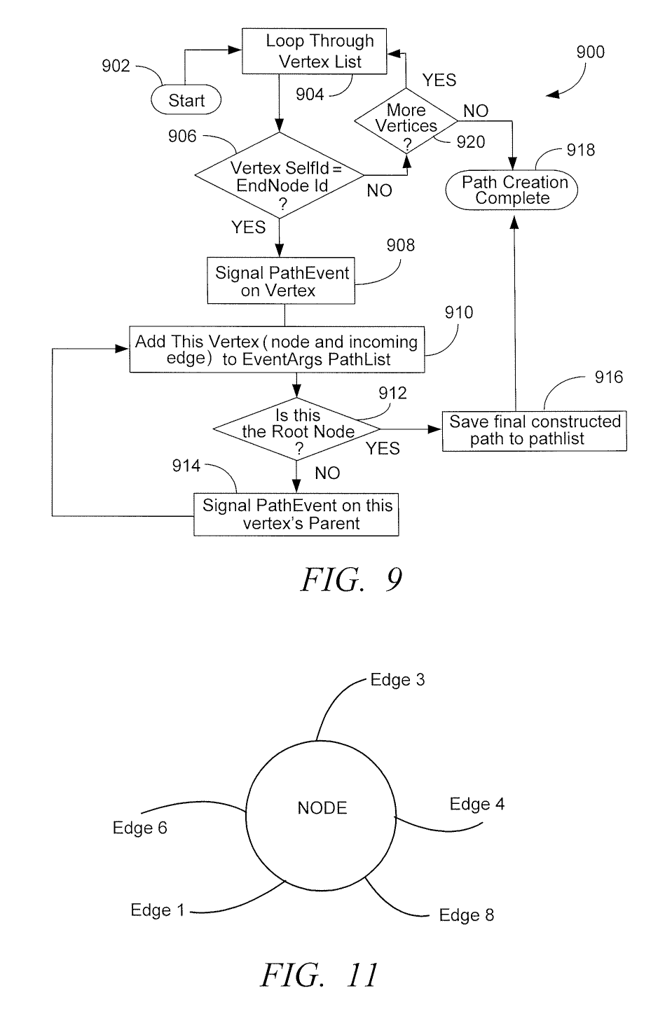

Once all of the paths from the End Node to the Start Node have been created, the paths must be reversed for general processing. The reversed nodes are assessed for “best path” based on the weighed values of the nodes and edges in each path. This best path is returned. FIG. 9 shows a flow chart of a reverse path construction algorithm 900 used by an exemplary embodiment of the mapping system.

The process illustrated in FIG. 9 starts at block 902. At block 904, the vertex list is looped through. At block 906, a determination is made whether Vertex.Self Id equals the destination Node ID. This process essentially build the collection of End Nodes where each End Node Vertex represents the termination of a unique path from the Start Node Vertex to this End Node Vertex. If the Vertex.Self Id equals the destination Node ID (the YES condition), the process continues to block 908 where a path event on a vertex is signaled. The process continues to block 910 where the vertex (node and incoming edge) is added to the Event Args Path List. At block 912, a determination is made whether the added vertex is the root node (essentially the Start Node) If not (the NO condition), the process continues to block 914 where a path event is signaled on this vertex's parent. The process then loops back to block 910 and continues with each subsequent vertex in the chain receiving a Path Event and adding its node and correlated edge to the EventArgs Path List. However, the added vertex is the root node at block 912 (the YES condition), the process proceeds to block 916 where the final constructed path is saved to the path list. The root vertex is unique because it does not have an incoming edge as all other vertexes in the constructed path. The process proceeds to block 918 such that the path creation is complete for all paths previously traversed in FIG. 8 from the Start Node Vertex to the End Node Vertices.

Alternatively, if at block 906 the Vertex.Self Id does not equal the destination Node ID (the NO condition), the process proceeds to block 920. At block 920 a determination is made whether there are more vertices. If there are more vertices, the process loops back to block 904. If there are no more vertices, the process proceeds to block 918 such that the path creation is complete.

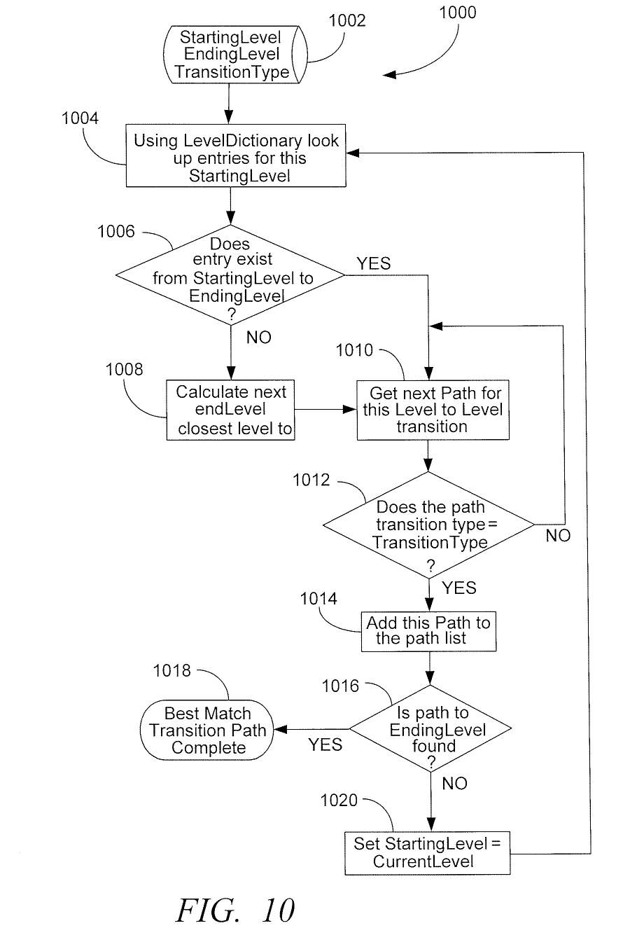

Additionally, the best match transition path that utilizes the Transition Type field of the Transition definition must be located. FIG. 10 shows a flow chart of a best match transition algorithm 1000 used by an exemplary embodiment of the mapping system.

The process of FIG. 10 begins at block 1002 where information pertaining to the starting level, the ending level and the transition type is obtained. Returning to the above-described example of traveling from the first floor to the fourth floor, the first floor is the starting level, the fourth floor is the ending level, and the elevator is the transition type.

Then, at block 1004, the Level Dictionary is used to look up entries for the Starting Level. At block 1006, a determination is made whether the entry is from the Starting Level to the Ending Level. If not (the NO condition), the process proceeds to block 1008 where the next closest level is calculated. The process then continues to block 1010. Alternatively, if the entry is from the Starting Level to the Ending Level (the YES condition), then continues to block 1010 to get the next path for the level to level transition.

The process then proceeds to block 1012, where a determination is made whether the path transition equals the Transition Type. If not, the process loops back to block 1010. If yes, the process proceeds to block 1014 such that the path is added to the path list. Proceeding to block 1016, a determination is made whether the path to the Ending Level has been found. If yes, the process proceeds to block 1018 such that the best match transition is complete. If not, the process proceeds to block 1020 where the Starting Level is set to equal the current level. The process then loops back to block 1004 and proceeds as described again until block 1018 is reached.

With this exemplary embodiment, each Node definition contains a list of Edge Ref definitions (Edge Ref List). Each Edge Ref represents an edge that enters or exits the node. The Edge Ref List is ordered in a relative clockwise manner. Each Edge Ref is given a relative value/index (increasing clockwise) indicating this edge relative to other edges in the node. Thus, left and right direction instructions may be determined for the recommended path.

Summarizing, one embodiment compares a level of a start node with a level of a destination node; in response to the level of the start node being different from the level of the destination node, selects at least one preferred transition between the level of the start node and the level of the destination node; for a first plurality of nodes and respective edges on the level of the start node, determines a first best sub-path from the start node to the transition; for a second plurality of nodes and respective edges on the level of the destination node, determines a second best sub-path from the transition to the destination node; and defines a recommended path corresponding to the first best sub-path, the transition, and the second best preferred sub-path. Other embodiments may determine the recommended path differently.

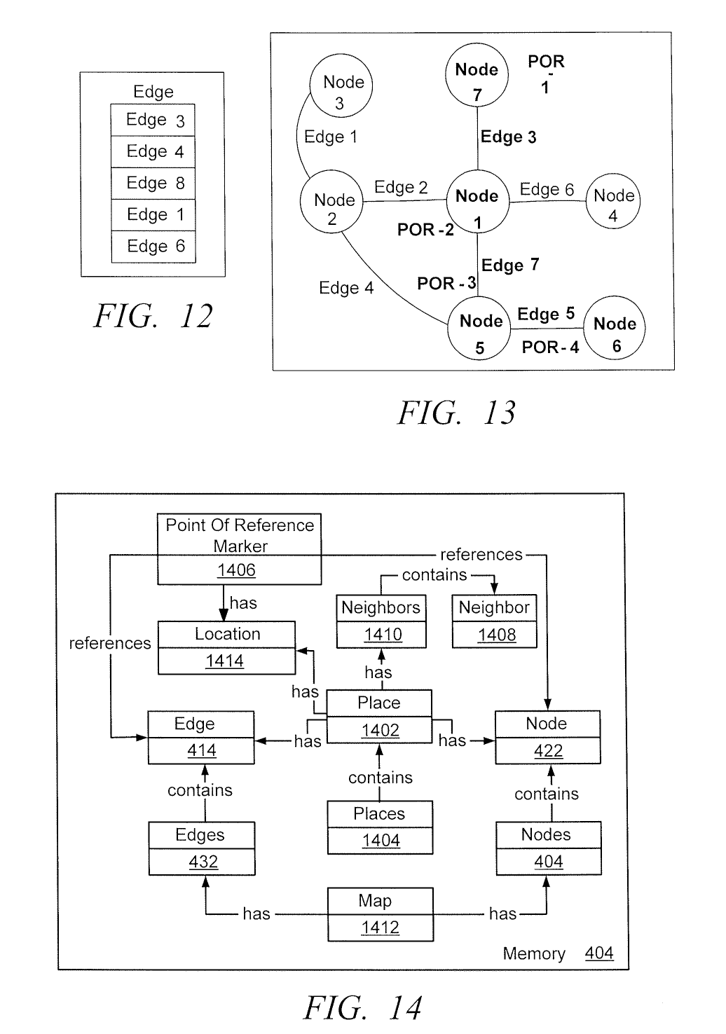

FIG. 11 shows node and edge reference definitions for establishing left and right direction instructions by an exemplary embodiment of the mapping system. FIG. 12 shows a diagram of an ordered array of edges for determining relative location by an exemplary embodiment of the mapping system. Here, Node A intersects with Edge 3, Edge 4, Edge 8, Edge 1, and Edge 6 (with reference to the Edge 3 at the top of node A and moving in a clockwise direction around Node A). Right/left turn directions may be determined from the incoming edge to the outgoing edge. For example, Edge 3 may be an incoming edge on a path where the direction of travel is into the node.

Left/right directions may then be determined. Left/right directions are determined for a path of travel by identifying the edge coming into the node. That is, the incoming edge is the edge used to travel to Node A. Given that the path has been defined, the outgoing edge is known.

For example, if the user is arriving at Node A via Edge 3, and the path of travel indicates that Edge 8 is the next edge to be traversed, then directions to the user will indicate that the user should make a right turn to enter Edge 8. If the next edge to be traversed is Edge 1, the directions to the user will indicate that the user should make a left turn to enter Edge 1.

In the various embodiments, determination of the recommended path relies on a weighting of the edges of the path (or sub-paths and transitions). Once the various paths or sub-paths for traveling through the architectural entity of interest from the start point to the destination are computed, the weighting of each edge or transition is retrieved for processing. Any suitable path weighting algorithm may be used. Generally, the path or sub-path with the least total weight will be the recommended path. In some cases, such as in the case where special needs are considered, one or more possible paths or sub-paths may be eliminated. Some embodiments may remove the eliminated paths or sub-paths from the family of possible paths or sub-paths. Other embodiment may assign a very high weighting to edges that are disqualified as being traversable based upon the nature of the special needs. For example, the weighting value of 99999 assigned to an edge or transition would effectively disqualify a path where typical path rating values were less than 1.0.

Point of Reference (POR) directions allow the directional information to be specific to the physical location but not rely on compass directions or street names. POR directions are almost always visual in nature and typically “line of sight” but can also be attributed to other human senses. POR directions provide directions that are context and location specific by utilizing significant points of reference markers in the map to guide from one location to the next.

A POR entity is used as a reference to an aide used in the specification of directions. The POR entity is typically a landmark (tree, bridge, stream, etc.) but can also be a distinctive sound for speech-based environment. For example, if the POR entity provides a visual cue to the user, the user may travel the recommended path based upon reference to the POR.

The various types of map entities are capable of supporting a point of reference marker. This allows graph objects (nodes and edges) to have designated Point of Reference markers. Further, places, such as arbitrary positions along the edges or within the nodes, may also have POR entities. Two specialty POR entities, a Starting Point of Reference and an Ending Point of Reference, allow directional information to be bounded by significant start/end designations.

FIG. 13 shows a node and edge representation for mapping point of reference (POR) entities. As noted above, a POR entity is an object or structure that is visibly and/or audibly recognizable by the user. For example, a ringing bell in a tower may be both a visible and audible POR entity. POR entities may be used in a map or in the directions provided to the user to assist the user in traversing the recommended path of travel. The map or directions may be entirely or partially based on POR entities. Use of POR entities may be a selectable feature or may be automatically used depending upon the embodiments and/or depending upon the nature of the architectural entity of interest.

As a simplified example, assume that the recommend path is traveling along Node 7 over Edge 3 to Node 1 over Edge 7 to Node 5 over Edge 5 to Node 6. Node 7 is the starting node and Node 6 is the destination node. The recommend path has already been identified, and now, maps and/or POR-based directions are to be determined by embodiments of the mapping system.

Assume that a POR-1 entity has been associated with Node 7, such as a “red sign” that is readily identifiable from Node 7. Also assume that a POR-2 entity (a “green sign”) has been associated with Node 1 and is readily identifiable by the user and visible from either node 7 and/or is visible while traversing Edge 3. Further assume that a POR-3 entity (a “blue sign”) is associated with Edge 7 and a POR-4 (a “yellow sign”) entity is associated with Edge 5.

A descriptor is associated with each POR entity in the map data. That is, for POR-1, the descriptor is “red sign” or the like. A POR may be associated with any meaningful descriptor that aids the user in recognizing the POR entity. The descriptor may describe visible characteristics of the POR entity. Alternatively, or additionally, the description may describe a characteristic that is discernable by another of the user's senses. For example, if the POR entity emits a sound, such as music or the like, the descriptor could describe the sound. As another example, if the POR entity is a bakery that specializes in chocolate deserts, the descriptor may describe the smell of baked chocolate. Any suitable descriptor, or combination of descriptors, may be used by the various embodiments.

A generic version of the resulting direction set for the above-described exemplary path are:
Starting at Source continue to POR-1
From POR-1 head towards POR-2.
Pass POR-2 and continue past POR-3
Turn Left and head towards POR-4
Destination is at the end of the walkway near Neighbor-1 and across from Neighbor-2.
   The nomenclature used in the above generic direction set is described in greater detail below.

Assuming that the mapping system embodiment is directed to generate a list of POR-based directions, the following exemplary directions may be generated.
First, walk to the red sign;
Next, look for the green sign and walk towards the green sign;
Next, after passing the green sign, the blue sign will become visible. Walk towards the blue sign;
Next, walk past the blue sign until the yellow sign becomes visible, and then turn right;
Finally, continue walking past the yellow sign and your destination will be straight ahead.

It is appreciated that any suitable presentation format of the directions may be used by the various embodiments. Further, the directions may be presented in a viewable written format and/or presented in an audible format.

Additionally, or alternatively, a graphical map may be generated with the POR descriptor printed thereon. Suitable icons of the POR may be presented. Further, actual images of the POR entity may be presented.

If characteristics of a Neighbor are associated with a node and/or edge, information corresponding to the node and/or edge characteristics may be included in the map or directions. Preferably, a Neighbor corresponds to an entity adjacent to or near the destination. For example, if a coffee shop is at or near the destination node, then the directions might be modified as follows: “Finally, continue walking past the yellow sign and your destination will be straight ahead next to the coffee shop.”

Further, node and/or edge characteristics may be used to indicate problems or issues that the user may encounter. For example, if the edge is not passable by a parent with a child's stroller, a suitable notification may be provided. As another nonlimiting example, if a ticket or pass is required to pass through a node or traverse an edge, a suitable notification may be provided.

FIG. 14 shows a block diagram of an exemplary alternative embodiment of the mapping system memory 404. The memory schema illustrates the relationships of data entities which support generation of POR directions. Other suitable memory schema may be used by other embodiments.

Place is the primary data item in the Point Of Reference schema. Place 1402 is a container that holds the context of a specific entity or point of interest on a map (a “place”). The Places 1404 collection holds the references to the place instances which relate to the map of interest. A place is defined as follows:

| | |
|---|---|
| Place ID: | Unique ID of this place |
| Name: | Friendly name of the place |
| Description: | Description of the place |
| Location: | Map location of this place including map, graph |
| | object id, graph object type |
| Address: | Street-grid location |
| Contact Info List: | List of Contact Info containing phone numbers, |
| | email and other contact information |
| Neighbors: | Collection of Place references which can be used |
| | as location references. |

The Map 412 contains the definition of the graph (nodes and edges) which define the area of interest. A map contains the following items of interest:
Edges: Collection of edge definitions (connections between nodes)
Nodes: Collection of node definitions (graph endpoints)

The Point of Reference Marker 1406 object contains the following key data items which are utilized at path resolution time to define the path:

| | |
|---|---|
| Reference ID: | Unique ID for this Point of Reference Marker |
| Reference Name: | Friendly name which can be used for text-only or |
| | text-to speech output. (i.e. The Fun Tower) |
| Description: | A short textual description elaborating on the POR |
| | (i.e. At night the Fun Tower is illuminated green) |
| Place ID: | ID of the Place referenced by this marker |
| Location: | Map location of this point of reference including |
| | map, graph object id, graph object type |
| Type: | Indicates the type of the reference (visual, sound, |
| | scent, taste, sense/feeling) |
| Audio: | Audio file used for sound-based references |

Neighbor 1408 is a reference to a place in relatively close proximity to the destination place. Neighbors may be used to further indicate proximity to the destination or may be used to provide other information of interest to the user. Neighbors 1410 is a collection of Neighbor objects used to provide proximity information specifically for the Ending POR. A neighbor contains the following key data items:
Place ID: Reference to a Place in proximity to the place of interest.
Relative Location Enumerated type indicating the proximity of this reference (above, below, next to, across from, etc.)
   For example, it the destination is a clothing store in a shopping mall, and there is an adjacent accessory shop, the accessory shop would be a neighbor. Information pertaining to the neighbor may be included in the presentation of a map or presentation of the directions to the destination.

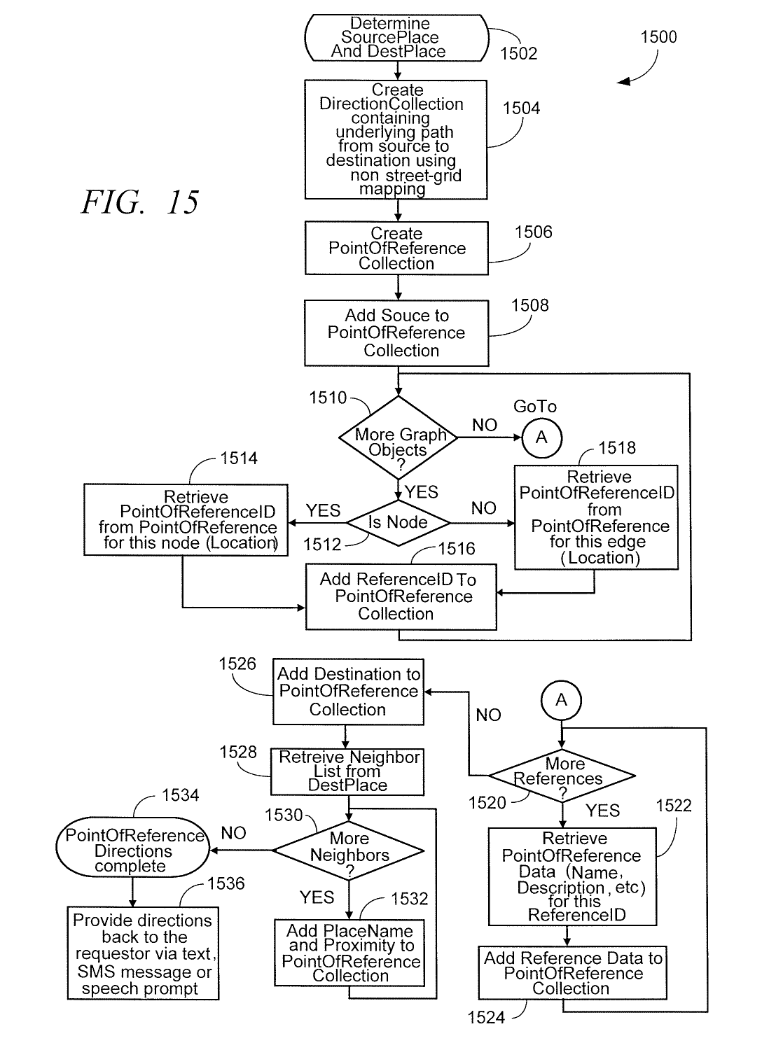

FIG. 15 shows a flow chart of a point of reference computing algorithm 1500 used by an exemplary embodiment of the mapping system. The process of FIG. 15 begins at block 1502 where information pertaining to the source place (start location) and the destination place (end location) is received. At block 1504, a Direction Collection is created which contains the underlying recommended path from the source place to the destination. The recommend path has been generated as described above. In some embodiments, the recommended path may come form a different source or be generated by and entirely different process and/or device.

At block 1506, a POR collection is created. At block 1508, the source is added to the POR collection. Then, at block 1510, a determination is made whether more graph objects are in the data for the recommended path. If not (the NO condition), the process proceeds to block 1520 described below. However, if more graph objects are in the data, the process proceeds to block 1512.

At block 1512, a determination is made whether the current graph object is a node. If the graph object is a node (the YES condition), the process proceeds to block 1514 where the POR ID (identification information) is retrieved for the node. Then, at block 1516, the POR ID is added to the POR collection. Alternatively, if the graph object is not a node (the NO condition), then the graph object is an edge (or transition). The process proceeds to block 1518 where the POR ID is retrieved for the edge. Then, at block 1516, the POR ID is added to the POR collection.

After completion of the process corresponding to block 1516, the process loops back to block 1510 and continues until there are no more graph objects (the NO condition). The process then proceeds to block 1520.

At block 1520, a determination is made whether there are more PORs. If yes, the process proceeds to block 1522 so that POR data is retrieved for the references. Then, at block 1524, the retrieved POR data is added to the POR collection. The process loops back to block 1520 and continues until there are no more PORs (the NO condition). The process then proceeds to block 1526.

At block 1526, the destination is added to the POR collection. At block 1528, the neighbor list is retrieved. Then, at block 1530, a determination is made whether there are Neighbors to be processed. If there are Neighbors to be processed (the YES condition), the process proceeds to block 1532 where information for the neighbor is placed in the POR collection. The process then loops back to block 1530 until all neighbors are processed.

However, if at block 1530 there are no remaining neighbors to be processed, the POR directions are determined to be complete at block 1534. At block 1536 the directions are generated. Directions may be presented to the user in text format short message system (SMS) format, speech prompt format, or any other suitable presentation format. Accordingly, the process of algorithm 1500 has been completed.

As noted above, a feature of interest is defined as a node or is associated with an edge. However, not all features of an architectural entity of interest need to be included in the predetermined map of an architectural entity of interest. The predetermined map of an architectural entity of interest may be updated as needed to include additional features, which may be defined as a node (with edges added corresponding to nearby connectable nodes) or associated with an already defined edge.

Some embodiments are described above with reference to directed graph theory. Alternative embodiments may use other path determination theory. For example, but not limited to, branch and tree theory may be used by alternative embodiments.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for determining a path through a multi-level architectural entity of interest, the method comprising:
comparing a level of a start node with a level of a destination node;
in response to the level of the start node being different from the level of the destination node, selecting at least one best match transition between the level of the start node and the level of the destination node, the best match transition including a transition start point on the level of the start node, a transition end point on the level of the destination, and a transition edge between the transition start point and the transition end point;
for a first plurality of nodes and respective edges on the level of the start node, determining a first sub-path from the start node to the transition start point;
for a second plurality of nodes and respective edges on the level of the destination node, determining a second sub-path from the transition end point to the destination node; and
determining a recommended path corresponding to the first sub-path, the second sub-path, and the best match transition.

2. The method of claim 1, wherein selecting the best match transition includes:
retrieving all transitions available for movement from the level of the start point to the level of the destination to form a transition set, each transition including a transition characteristic; and
selecting the best match transition from the transition set based upon the transition characteristic.

3. The method of claim 2, wherein selecting the best match transition further comprises:
comparing each recommended path according to a path characteristic;
determining at least one best match path based in response to the recommended path matching the characteristic; and
selecting a best match transition based upon inclusion in the best match path.

4. The method of claim 3, wherein the path characteristic in determining the best match path from the plurality of best matched paths is based on the shortest time required to traverse the best match path.

5. The method of claim 2, wherein selecting the best match transition includes:
eliminating at least one transition from the set based upon the transition characteristic.

6. The method of claim 2, wherein receiving all transitions includes:
defining as a combined transition a first transition in series with a second transition, the first transition having a first transition start point, a first transition end point and a first transition edge, and the second transition having a second transition start point, and a second transition edge, such that the combined transition start point is the first transition start point and the combined transition end point is the second transition end point, and such that an intermediate path edge is between the first transition end point and the second transition start point;
defining an intermediate path between the first transition end point and the second transition start point, the intermediate path having an intermediate path edge and that a combined transition edge includes characteristics from the first transition edge, the second transition edge and the intermediate path edge.

7. The method of claim 1, wherein selecting the best match transition further comprises:
identifying a first node of the best match transition that is on the same level as the start node such that the first best sub-path is determined from the start node to the first node of the transition; and
identifying a second node of the best match transition that is on the same level as the destination node such that the second best sub-path is determined from the second node of the transition to the destination node.

8. The method of claim 1, further comprising:
generating a map corresponding to a path of travel over of the recommended path.

9. The method of claim 1, further comprising:
generating a plurality of left turn and right turn directions corresponding to a path of travel over the recommended path.

11. The method of claim 1, further comprising:
receiving a request for path instructions, the request identifying the architectural entity of interest, identifying a start point in the architectural entity of interest, and identifying a destination in the architectural entity of interest;
defining the start node to correspond to the start point; and
defining the destination node to correspond to the destination.

12. The method of claim 1, further comprising:
receiving a request for special needs, the request identifying special needs of a person; and
identifying at least one special needs transition from a plurality of transitions such that the special needs transition is the best match transition.

13. The method of claim 1, further comprising:
receiving a request for special needs, the request identifying special needs of a person; and
identifying from a plurality of transitions at least one disqualified transition that is not compatible with the special needs such that the disqualified transition is not selectable as the best match transition.

14. The method of claim 1, wherein determining a first best sub-path from the start node to the best match transition comprises:
defining a node of the best match transition that is on the level of the start node as an end node for the first level; and
constructing a tree of vertices from the start node to the end node of the first level;
selecting at least one path on the tree of vertices between the start node and the end node of the first level as the first best sub-path.

15. The method of claim 1, further comprising:
performing reverse path construction for the first best sub-path.

16. A system operable to determine a path through a multi-level architectural entity of interest, the path having a start point and a destination, comprising:
a memory operable to store a map of the multi-level architectural entity of interest defined as a plurality of nodes, a plurality of edges, and at least one transition between a first level corresponding to the start point and a second level corresponding to the destination; and
a processing system operable to:
select at least one best match transition between the first level of the start node and the second level of the destination node;
for a first plurality of nodes and respective edges on the first level, determine a first best sub-path from the start node to the transition;
for a second plurality of nodes and respective edges on the second level of the destination node, determine a second best sub-path from the transition to the destination node; and
determining a recommended path corresponding to the first best sub-path, best match transition, and the second best preferred sub-path.

17. The system of claim 16, further comprising:
an input interface operable to receive a request for path instructions, the request identifying the multi-level architectural entity of interest, identifying the start point in the architectural entity of interest, and identifying the destination in the architectural entity of interest;

18. The system of claim 16, wherein the processing system is operable to generate at least one of a travel map and a set of directions corresponding to a path of travel over of the recommended path, further comprising:
an output interface operable to output at least one of the travel map and the set of directions determined by the processing system.

19. The system of claim 16, further comprising:
an input interface operable to receive the map of the multi-level architectural entity of interest from a database wherein a plurality of maps for different multi-level architectural entities of interest reside.

20. A method for determining a recommended path for traversing through a multi-level architectural entity of interest, the recommended path determined in part from a best sub-path on a first level that traverses from a start node on the first level to a transition start node of a transition on the first level, the transition connecting the first level with a second level, the method comprising:
for each node of the best sub-path on the first level, starting with the transition start node, adding the node and a respective incoming edge to a path list for the first level; and
in response to adding all nodes of the best sub-path to the path list for the first level, reverse ordering the nodes and edges of the path list for the first level.

21. The method of claim 20, further comprising:
signaling a last Vertex Path Event of the best sub-path for the first level in an event chain.

22. The method of claim 20, further comprising:
determining a route for the first level that traverses from the start node to the transition start node from the reverse ordered path list for the first level.

23. The method of claim 22, for a best sub-path on the second level that traverses from an end node of the transition to a destination node, further comprising:
for each node of the best sub-path on the second level, starting with the destination node, adding the node and its respective incoming edge to a path list for the second level; and
in response to adding all nodes of the best sub-path on the second level to the path list for the second level, reverse ordering the nodes and edges of the path list for the second level; and
determining a route on the second level that traverses from the end node of the transition to the destination node from the reverse ordered path list for the second level.

24. The method of claim 23, further comprising:
combining the determined rout for the first level, the transition, and the determined route for the second level such that a path for traversing from the start node to the destination node is determined.
